(19) United States
(12) Patent Application Publication
(10) Pub. No.: US 2012/0104300 A1
(43) Pub. Date: May 3, 2012

(54) COMPOSITE SEAL

(76) Inventors: Peter J. Dowd, Granby, CT (US); John M. Dehais, Windsor, CT (US); Rosanna C. Glynn, Cromwell, CT (US); Jay Stradinger, Enfield, CT (US); Marc E. Gage, Feeding Hills, MA (US); Kevin M. Rankin, Windsor, CT (US)

(21) Appl. No.: 12/915,099

(22) Filed: Oct. 29, 2010

(51) Int. Cl. F16K 25/00; B21K 1/20; F16J 15/02; F16K 1/22

(52) U.S. Cl. 251/170; 251/305; 29/890.124; 277/650

(57) ABSTRACT

A seal ring assembly has a carbon member extending between spaced ends, and with a step at an outer periphery. A ring is received in the step to maintain spaced ends of the carbon member towards each other. A valve disc and shaft, a butterfly valve, and a method of installing a carbon ring seal are also disclosed. In a separate feature, a valve housing for a butterfly valve includes a first housing portion defining a flow passage, and a second housing portion extending integrally from the first housing portion, and defining a space to mount a valve shaft.

### BACKGROUND

This application relates to a composite seal which is to be used in a butterfly valve. Also, a valve housing is disclosed.

Butterfly valves are known and include a valve disc which rotates or pivots within a flow channel to control the pressure and flow of fluid through the channel. Butterfly valves preferably require good sealing at an outer periphery such that fluid cannot leak beyond the valve when the valve is in a closed position.

In the prior art, two general types of seals have been proposed. In a first seal, a metal ring is placed within the outer periphery of a valve disc. However, metal seals are subject to wear, and thus there is added leakage.

Carbon materials are also utilized to form the seal. Carbon materials are more resistant to wear, and thus may not have the concern of a metal seal. However, carbon seals are prone to oxidation if the valve disc is exposed to high temperature.

In many aircraft applications, the valve disc and seals are exposed to temperatures above 1000° F. (538° C.) for extended periods of time.

The valve discs have typically been rotated within the channel by an actuated pneumatic piston. The valve disc is connected to a shaft which extends through a shaft housing. In the prior art, the shaft housing is attached to a housing defining the flow passage as two separate components.

### SUMMARY

A seal ring assembly has a carbon member extending between spaced ends, and with a step at an outer periphery. A ring is received in the step to maintain spaced ends of the carbon member towards each other. A valve disc and shaft, a butterfly valve, and a method of installing a carbon ring seal are also disclosed.

In a separate feature, a valve housing for a butterfly valve includes a first housing portion defining a flow passage, and a second housing portion extending integrally from the first housing portion, and defining a space to mount a valve shaft.

These and other features of the present invention can be best understood from the following specification and drawings, the following of which is a brief description.

### BRIEF DESCRIPTION OF THE DRAWINGS

FIG. 1 shows a butterfly valve and housing.

FIG. 2 shows a detail of a valve disc.

FIG. 3 shows a detail of a seal assembly.

FIG. 4 shows a seal assembly.

### DETAILED DESCRIPTION

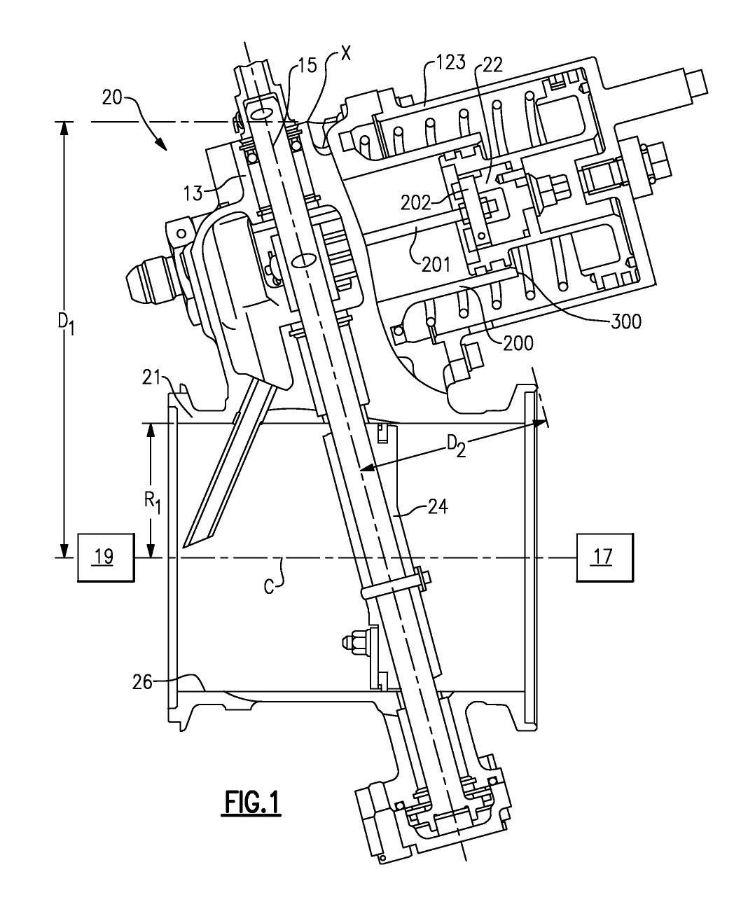

A butterfly valve assembly 20 is shown in FIG. 1 and has a housing 21 providing a flow passage 26. A motor or actuator 22 causes a disc 24 to pivot relative to a flow passage 26, and control flow from an inlet 19 into an outlet end 17. The inlet 19 may be a source of air in an aircraft air supply system, and the outlet 17 may be a downstream location where the air is utilized on the aircraft. The air supply system could be for passenger cabin air, flight deck or cargo air, as examples.

As shown in FIG. 1, the motor actuator 22 is a pneumatic motor actuator held within a housing 123. A valve shaft 15 extends through the disc 24 and into an actuator housing portion 13. The actuator housing portion 13 can be seen to be formed integrally with the valve housing portion 21 that forms the flow passage 26. In a disclosed embodiment, a radius of the flow passage 26, R₁ was 1.45″ (3.68 cm). In that same embodiment, a distance D₁ from a center line C to a point X, which is the point on the housing portion 13 most remote from the center line C and measured perpendicular to line C, was 4.715″ (11.98 cm). In embodiments, a ratio of the distances D₁ and R₁ was between 2.5 to 4.0, and more narrowly 3.0 to 3.5. By forming the housing portion 13 integrally with the flow passage housing portion 21, a more robust housing assembly is provided.

In addition, a third housing portion 200 extends integrally away from the housing portion 13, and receives a portion of the pneumatic motor actuator 22, and at least shaft 201 and piston 202. As shown, a distance D₂ is defined between a center line of a bore in the housing portion 13 that receives the shaft 15, and an end 300 of the third housing portion 200. As can be appreciated, third housing portion 200 is generally cylindrical. In one embodiment, D₂ was 2.085″ (5.29 cm). In embodiments, a ratio of D₁ to D₂ is between 1 and 4.

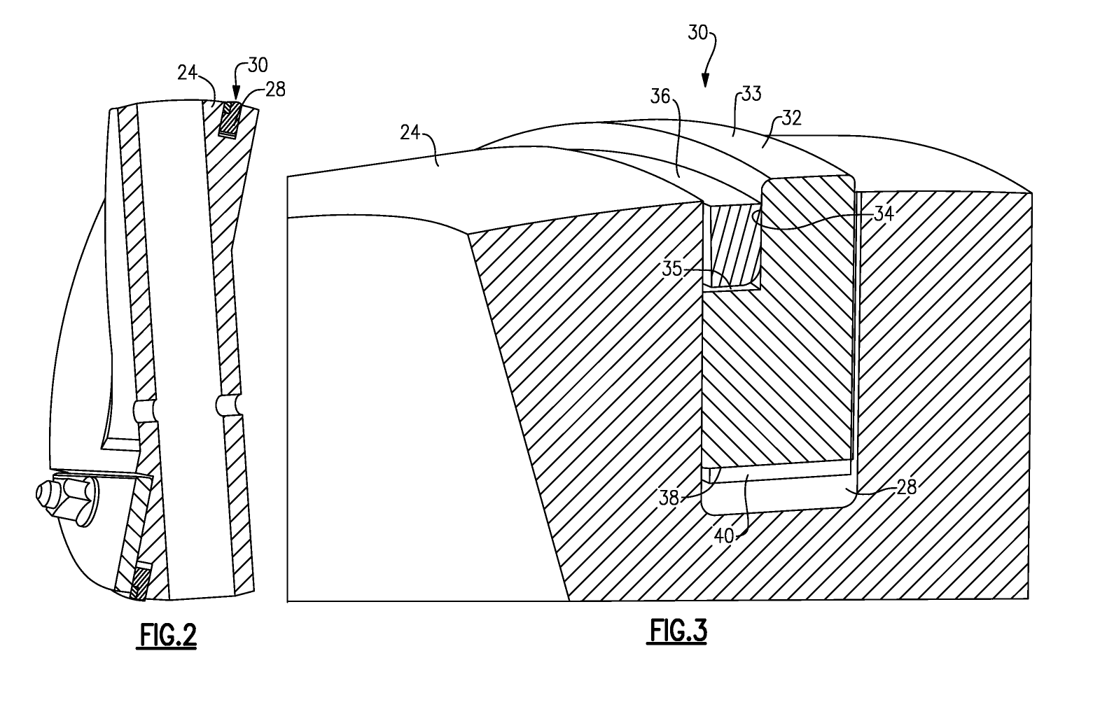

As can be seen in FIG. 2, the disc 24 is provided with a seal groove 28 at an outer periphery. A seal assembly 30 is positioned in the groove 28.

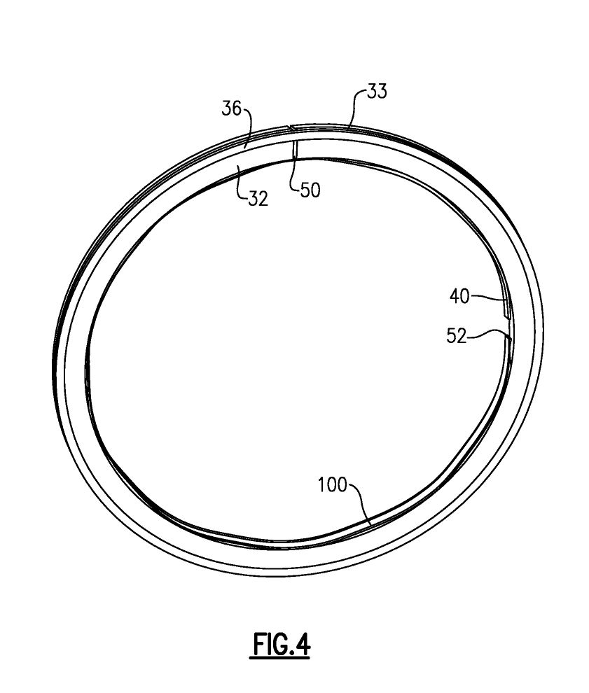

As can be seen in FIG. 3, the seal assembly 30 includes carbon based member 32 having a radially outer face 33 which will contact a wall of passage 26 and provide a seal. A step 34 is formed into the carbon member 32. A retainer band or metal ring 36 is received in the step 34. There is a small clearance between an outer surface 35 of the step, and the inner surface of the metal ring 36 when the disc 24 is in the closed position. Further, a radially bottom end 38 of the carbon member 32 provides a contact surface for a spring 40. Spring 40 biases the carbon member 32 radially outwardly and against metal ring 36 and passage 26. This ensures an adequate seal.

As can be appreciated from FIG. 4, the metal ring 36 is continuous. The carbon member 32 has ends 50. These ends 50 facilitate the insertion of the carbon ring into the groove 28. However, the metal ring 36 ensures the ends do not separate, and that the carbon member 32 is held together. The spring 40 biases the carbon member 32 radially outwardly, again ensuring the surface 33 is held against the surface of the passage 26. As can be appreciated, there are waves 100 in the spring 40. Deflection of the waves 100 assist the spring 40 in biasing off of the bottom surface of the groove 28, and maintaining the carbon member 32 biased radially outwardly.

In assembling the seal assembly 30, the spring 40 is initially placed within the groove 28. As can be appreciated from FIG. 4, there may be ends 52 between the spring 40, such that the spring 40 is one elongate member. The carbon member 32 is then placed into the groove 28, and the metal ring 36 is then moved into the step 34. The valve disc 24 may then be operated to control the flow through the passage 26 and regulate pressure.

Butterfly valves are also subject to external vibratory and flow perturbation loads. This can cause the disc assembly to be impacted in a destructive manner. The spring 40 applies a radial load to the disc which can assist in resisting these externally applied loads.

In one embodiment, the metal ring 36 is formed of an appropriate steel, such as 17-4PH. In an embodiment, the spring 40 is formed of a material known under the trade name Inconel X-750. Although described as a metal ring, the ring 36 can be constructed of carbon graphite, or other appropriate material. Of course, numerous other materials can be used.

The carbon member 32 is preferably formed of a carbon material having heat resistant additives. One known carbon material which may be utilized is available from a company called Carbone under its trade name JP1033. Carbon JP1033 is a very fine-grain graphite material, and contains aluminum phosphorous oxidation inhibitors. The presence of an oxidation inhibitor inhibits the reaction of the graphite material with oxygen in the air at elevated temperatures. Similar oxidation inhibitors such as zinc phosphorous compounds have been utilized with other carbon materials, and may be appropriate selections for the present application. However, Carbon JP1033 also has excellent wear resistance. The Carbon JP1033 carbon member has proven to have exceptional performance at temperatures over 1000° F. (538° C.).

The dimensions and ratios are associated with specific embodiments, and do not limit the broader ranges of these concepts.

Although embodiments of this invention have been disclosed, a worker of ordinary skill in this art would recognize that certain modifications would come within the scope of this invention. For that reason, the following claims should be studied to determine the true scope and content of this invention.

What is claimed is:

1. A seal ring assembly comprising:
a carbon member extending between spaced ends, and having a step at an outer periphery; and
a continuous ring received in said step, said continuous ring maintaining said spaced ends of said carbon member towards each other.

2. The seal ring assembly as set forth in claim 1, wherein a spring is positioned at a radially inner surface of said carbon member to bias said carbon member radially outwardly and against said ring.

3. The seal ring assembly of claim 2, wherein said spring is provided with waves.

4. The seal ring assembly as set forth in claim 1, wherein said carbon member is formed of a graphite material including oxidation inhibitors.

5. The seal ring assembly as set forth in claim 4, wherein said oxidation inhibitor is one of aluminum phosphorous or zinc phosphorous.

6. The seal ring assembly as set forth in claim 1, wherein said ring is formed of a metal.

7. A valve disc and shaft comprising:
a valve disc having a seal groove at an outer periphery;
a shaft for causing said valve disc to rotate, there being a carbon seal ring assembly in said seal groove; and
the carbon seal ring assembly including a carbon member extending between spaced ends, and having a step at an outer periphery, a metal ring received in said step, said metal ring maintaining said spaced ends of said carbon member towards each other.

8. The valve disc and shaft as set forth in claim 6, wherein a spring is positioned at a radially inner surface of said carbon member to bias said carbon member radially outwardly and against said metal ring.

9. The valve disc and shaft as set forth in claim 8, wherein said spring applies a radial load to said disc to resist external loads.

10. The valve disc and shaft as set forth in claim 6, wherein said carbon member is formed of a graphite material including oxidation inhibitors.

11. The valve disc and shaft as set forth in claim 8, wherein said oxidation inhibitor is one of aluminum phosphorous or zinc phosphorous.

12. A butterfly valve comprising:
a valve housing body defining a flow passage, and mounting a shaft in an actuator for rotating a valve disc, said valve disc having a seal groove at an outer periphery, and said shaft for causing said valve disc to rotate, there being a carbon seal ring assembly in said seal groove; and
the carbon seal ring assembly including a carbon member extending between spaced ends, and having a step at an outer periphery, a metal ring received in said step, said metal ring maintaining said spaced ends of said carbon member towards each other.

13. The butterfly valve as set forth in claim 12, wherein a spring is positioned at a radially inner surface of said carbon member to bias said carbon member radially outwardly and against said metal ring.

14. The butterfly valve as set forth in claim 12, wherein said carbon member is formed of a graphite material including oxidation inhibitors.

15. The butterfly valve as set forth in claim 14, wherein said oxidation inhibitor is one of aluminum phosphorous or zinc phosphorous.

16. The butterfly valve as set forth in claim 21, wherein said valve housing body having a first portion defining a flow passage receiving said valve disc, and a second portion extending integrally from said first portion, and defining a space to receive said shaft, with said actuator being attached to said body as a separate housing.

17. A method of installing a carbon seal ring assembly on a butterfly valve disc of a butterfly valve comprising the steps of:
(a) forming a seal groove at an outer periphery of a butterfly valve disc;
(b) placing a spring within said seal groove, and inserting a carbon member having spaced ends into said seal groove, said carbon member being formed with a ring groove at a radially outer location; and
(c) placing a metal ring within said ring groove to hold said carbon member.

18. The method as set forth in claim 17, wherein said butterfly valve disc is mounted within a housing, such that said butterfly valve disc can rotate to control the flow of fluid through a flow passage in said housing.

19. A butterfly valve housing comprising:
a valve housing having a first portion defining a flow passage, and a second portion extending integrally from said first portion and providing a space to mount a shaft.

20. The housing as set forth in claim 19, wherein a third portion extends from said second portion, and defines a space to receive a piston and shaft of an actuator, said third portion being formed integrally with said first and second portion.

21. The housing as set forth in claim 20, wherein a center line of said flow passage defines a first distance to a location on said second portion which is spaced furthest from said center line, and a ratio of said distance to a radius of said flow passages is between 2.5 and 4.0.

22. The housing as set forth in claim 21, wherein a ratio of said first distance to a second distance defined between the center of a bore for receiving the shaft and an end of said third portion is between 1 and 4.

23. A valve disc and shaft comprising:
a valve disc body having a groove at an outer periphery;
a shaft for causing said valve disc to rotate, there being a carbon seal ring assembly in said groove; and
said carbon seal ring assembly including a carbon member formed of a graphite material including oxidation inhibitors.

24. The valve disc and shaft as set forth in claim 23 wherein said oxidation inhibitor is one of aluminum phosphorous or zinc phosphorous.
